(19) United States
(12) Patent Application Publication
(10) Pub. No.: US 2007/0144748 A1
(43) Pub. Date: Jun. 28, 2007

(54) Sprinkler System Corrosion Control

(76) Inventors: Gerald M. Clum, Waverly, PA (US); Eric M. Clum, Olyphant, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/685,243

(22) Filed: Mar. 13, 2007

Related U.S. Application Data
(63) Continuation-in-part of application No. 10/895,536, filed on Jul. 21, 2004.
(60) Provisional application No. 60/569,954, filed on May 11, 2004.

(51) Int. Cl. A62C 35/00

(52) U.S. Cl. 169/17

(57) ABSTRACT

A method and system for controlling bacteria growth in a sprinkler system includes operating a sprinkler network in a normally substantially dry condition, and applying a vacuum apparatus to evacuate air from the network to create a negative air pressure within the network, so that bacteria growth within the network is inhibited. The vacuum is automatically re-applied to the network if the negative air pressure is lost.

### CROSS REFERENCE TO RELATED APPLICATIONS AND CLAIM OF PRIORITY

This application claims priority to as a continuation-in-part, and incorporates by reference in its entirety, co-pending U.S. Patent Application No. 10/895,536, entitled “lire Protection Sprinkler System,” filed Jul. 21, 2004, which in turn claims priority to U.S. Provisional Application No. 60/569,954 entitled “Fire Protection Sprinkler System” and fled May 11, 2004.

### STATEMENT REGARDING FEDERALLY SPONSORED RESEARCH

Not Applicable.

### NAMES OF PARTIES TO A JOINT RESEARCH AGREEMENT

Not Applicable.

### SEQUENCE LISTING

Not Applicable.

### BACKGROUND

1. Technical Field

The present invention generally relates to fire protection sprinkler systems. More particularly, the present invention relates to a method and apparatus for inhibiting the growth of microbiologically influenced corrosion in a fire protection sprinkler system.

2. Description of the Related Art

Most commercial buildings, hotels, hospitals and nursing homes are required by law to include fire extinguishing sprinkler systems in the building, In addition, sprinkler systems are increasingly used in residential applications, including apartment buildings, condominiums and homes. The sprinkler systems are generally housed in or near the ceilings of one or more floors of the building and are made of pipes having varying diameters. The systems are fed by a water supply line and are designed to deliver large amounts of water to a fire upon activation. The systems are typically activated when smoke or intense heat is detected.

Sprinkler systems can be classified in two general categories: “wet” systems and “dry” systems. A “wet” system's pipes are permanently filled with water, which is immediately expelled through the sprinkler heads when the system is activated. Although wet systems have the benefit of immediate delivery of water upon activation, they are not suitable for installations where any part of the system is at risk for damage caused by freezing water. In addition, wet systems can serve as breeding grounds for corrosion-causing bacteria that may corrode sprinkler pipes and other system components. Microbiologically induced corrosion (MIC) is a common way to refer to corrosion that is caused by microscopic organisms or microbes.

“Dry” systems are available for installations where a risk of freezing exists or where avoidance of water flow or leakage is critical. In current dry systems, the system's pipes are generally empty of water. Air pressure is used in such systems to force air out of the pipes. When the air pressure is relieved, water flows into the pipes and is delivered to the heads. The resistance created by the water forcing the air out adds to the time that it takes for the water to reach the sprinkler heads.

A few prior art systems have attempted to overcome these problems by applying a vacuum to the system. However, these systems also contain several disadvantages. For example, U.S. Pat. No. 5,927,406, to Kadoche, describes a sprinkler system to which a vacuum is applied. The system activates and delivers water to the system whenever the system is returned to atmospheric pressure. However, the system in Kadoche requires specially designed sprinkler heads. Moreover, the system contains no means of distinguishing between a pressure change that is due to a fire and a pressure change that results from a sprinkler head malfunction.

U.S. Pat. No. 6,715.561, to Franson, describes another vacuum system that requires specially designed sprinkler heads. The requirement of specially designed heads creates a significant financial deterrent to the use of the existing vacuum systems. Moreover, the system poses a significant risk of water damage to a building and its contents if any sprinkler head malfunctions or is damaged.

The problem with using standard systems and sprinkler heads For dry sprinkler systems has made sprinkler systems impractical in many residential settings. Currently, in residential settings a dry system must be filled with compressed air, which requires expensive heavy-duty piping and control equipment. Alternatively, a residential system may be ordinarily wet (i.e., filled with water), which creates risks of freezing and leaks. In additions in a wet system, the water, which is in contact with air in the pipes, can serve as an especially fertile ground for bacteria growth and MIC. Given the right conditions, MIC has been observed to cause perforation failure of a piping system in less than two weeks from startup of a sprinkler system.

In current dry systems, some residual amounts of water may remain in system pipes and sprinkler heads. Dry systems may exhibit more severe corrosion than wet systems. In dry systems there may be puddles of residual water in the system, and the presence of oxygen. The oxygen in the air and the residual water create an environment in which aerobic microorganisms can thrive, and provide the potential for severe MIC.

MIC is caused by a variety of microorganisms including, but not limited to, aerobic bacteria, anaerobic bacteria, acid forming bacteria, slime formers, and sulfate reducing bacteria. While MIC can result in perforation of sprinkler system tubing, it can also result in blockage of the pipes and sprinkler heads. MIC can lead to tuberculation and corrosion, which can result in pinhole leaks in carbon steel, galvanized steel, and copper pipes used in sprinkler systems

MIC needs to be a concern for any organization or residence owner that relies on a sprinkler system for as a fire protection system. In particularly sensitive locations, such as in semiconductor industry clean rooms, even a small drip from a sprinkler system pipe can cause production problems and shut downs. Owners of fire protection sprinkler systems need to expend time to periodically inspect their sprinkler systems, spend money on water treatment chemicals, and continuously monitor corrosion.

U.S. Pat. No. 6,758,282 discloses a tire protection water sprinkler system in which the inside of the pipes are coated with ammonium salt, filming amine and/or synthetic oil. The coating inhibits microbiological influenced corrosion.

U.S. Pat. No. 6,960,321 discloses a method for sterilizing sprinkler systems. The method includes flushing the system with a sterilizing gas, which could be steam, oxygen, or chlorine. After sterilization, the water used to fill the system can also be sterilized.

U.S. Pat. No. 6,221,263 discloses a device that automatically introduces chemicals into the water of a sprinkler system. The chemicals kill microbes to inhibit or eliminate MIC.

U.S. Pat. No. 6,605,254 discloses fumigating sprinkler systems with a gas that kills microbes that cause MIC. Effective gasses include alkylene oxide, chlorine dioxide, fluorine dioxide, ozone, hydrogen peroxide, and methyl bromide.

U.S. Pat. No. 6.841,125 discloses a treatment that inhibits chemical corrosion and MIC for the inside of pipes of a sprinkler system. The method includes injecting a pressurize foam to clean the pipes, followed by treatment with an antimicrobial, anticorrosion coating.

U.S. lat. No. 60,517617 discloses a method and apparatus to clean ferrous surfaces, and in particular fire protection systems, A foam is deposited in a sprinkler system that inhibits microbiologically influenced corrosion (MIC).

Current MIC prevention schemes require the use of toxic chemicals and/or expensive equipment. Consequently, a need exists for a sprinkler system and a method of operating a sprinkler system in which the growth of bacteria can be inhibited or retarded, which does not require dangerous and expensive materials and schemes.

This disclosure contained herein is directed to solving one or more of the above-described problems.

### SUMMARY

An embodiment of a method for controlling bacteria growth in a sprinkler system may include operating a sprinkler network in a normally substantially dry condition, applying a vacuum apparatus to evacuate air from the network and create a negative pressure within the network so that bacteria growth within the network is inhibited, and automatically re-applying the vacuum apparatus to the network if the negative pressure is lost.

In an exemplary embodiment the negative pressure may be automatically maintained at a pressure between about 2 inches and about −10 inches of mercury. In still another embodiment, the pressure may be monitored using a pressure regulator to monitor pressure within a tank of the vacuum apparatus.

In a further embodiment, re-applying the vacuum apparatus may include activating the vacuum apparatus when the pressure regulator detects a pressure in the tank that is less negative than a first predetermined level. An embodiment may include deactivating the vacuum apparatus when the pressure regulator detects a pressure within the tank that is more negative than a second predetermined level.

A method for controlling bacteria growth in a dry sprinkler system may, include connecting a vacuum apparatus to a sprinkler system. In an exemplary method, an evacuated condition may be established in the sprinkler system by the vacuum apparatus. The evacuated condition may be a negative air pressure that is within a design pressure capability of the sprinkler system, and the evacuated condition inhibits bacteria growth in the sprinkler system. In an embodiments negative pressure within the apparatus may be monitored by a pressure regulator, and the apparatus may be turned on or oft depending on the monitored pressure level of the apparatus.

### BRIEF DESCRIPTION OF THE DRAWINGS

FIG. 1 is a block diagram illustrating exemplary features of a dry sprinkler system according to an embodiment.

FIGS. 2A, 2B and 2C illustrate exemplary sprinkler system network configurations,

FIG. 3 is a block diagram depicting elements of an exemplary vacuum application apparatus.

FIG. 4 is a flow diagram that illustrates exemplary steps in a method described herein.

### DETAILED DESCRIPTION

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the present invention which will be limited only by the appended claims. It must also be noted that as used herein and in the appended claims, the singular forms “a,” “an,” and “the” include plural references unless the context clearly dictates otherwise. In addition, the word “comprising” as used herein means “including but not limited to.” All patent documents mentioned herein are incorporated herein in their entireties.

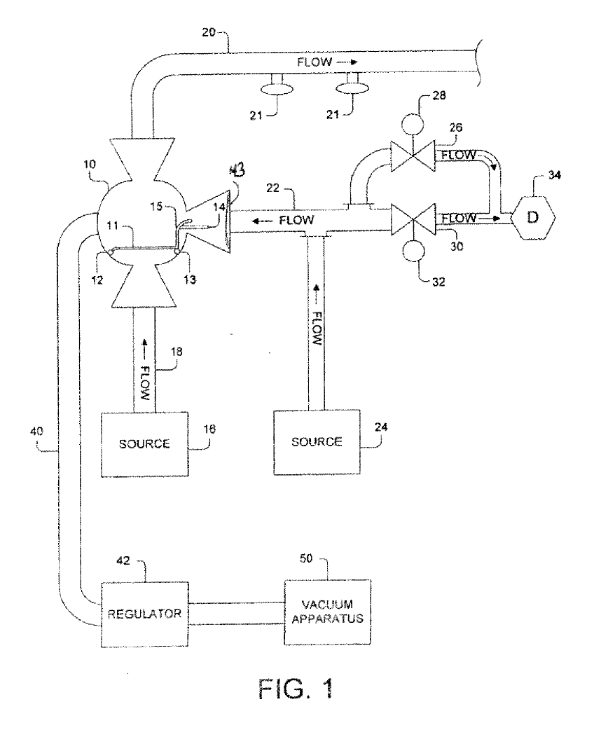

Referring to FIG. 1, an embodiment of a novel dry sprinkler system is illustrated in a block diagram. The exemplary system includes a valve 10 that receives water from a first water source 16 via a source pipe 18. The valve controls the delivery of water from the first source 16 to a plurality of sprinkler heads 21 via one or more pipes 20. Preferably, each port of the valve 10 is connected by a water-resistant gasket or seal (not shown) to its corresponding piping (i.e., the first source 16, piping 22 and/or the sprinkler network 20).

In an embodiment, the valve 10 may be a three-way valve that also receives water from a second source 24. The valve 10 includes a seat 11 that seals off the flow of water from first source 16 when water pressure is also present from second source 24. The seat 11 may be made of any durable, water-resistant material. In a preferred embodiment, the seat 11 is made of brass with a hard neoprene rubber coating. However, those skilled in the art will recognize that the seat 11 may be made of other materials as well. The seat 11 may be positioned to contact a pin, seal, or other rim 12 to provide a complete seal for flow from first source 16. The seat may be connected to a camber 15 and/or pin or piston 14 to collectively swivel about a hinge 13. The pin or piston 14 may contact a diaphragm 43 that pushes pin 14 into the valve to hold seat 11 down and prevent the flow of water from first source 16 when water from second source 24 exerts pressure against diaphragm 43. Thus, under normal conditions, no water flows through the sprinkler pipes 20. When a fire event occurs valve 30 and/or valve 26 may open and permit water from second source 24 to flow to flow to a drain 34, thus relieving pressure from diaphragm 43, allowing pin 14 to move outward so that water pressure from first source 16 pushes scat 11 inward and the water flows into the sprinkler system 20.

The valve 10 may be any commercially available three-way valve, such as those made by Victaulic Co. Reliable Automatic Sprinkler Co., and Globe lire Sprinkler Corp. However, for such commercially available valves, modification may be required to ensure that the seat 11 does not pull up and allow water to flow from the source 16 into the system 20 when a vacuum is applied. Such modifications may include using a stronger hinge 12 and/or a stronger spring-loaded camber 15 and hinge 13 mechanism.

When the sprinkler system is inactive, the sprinkler piping 20 is substantially dry. The piping 20 is evacuated to remove at least 90% of the oxygen, or at least 95% of the oxygen, or substantially all of the oxygen from the piping 20 so that piping 20 is maintained at a vacuum level during periods of inactivity. The negative pressure is preferably below atmospheric pressure at a level between about −2 inches and about −15 inches of mercury more preferably between −2 inches and −10 inches of mercury, and even more preferably at about −10 inches of mercury. Air may be withdrawn from the piping 20 using vacuum apparatus 50 to withdraw air from the piping through a vacuum delivery channel 40. The vacuum delivery channel 40 must be airtight to permit the vacuum apparatus 50 to apply the vacuum. Optionally the vacuum apparatus 50 may be capable of applying further negative pressures such as pressures in the range of about −1-to −27 or about −10 to about −30 inches of mercury.

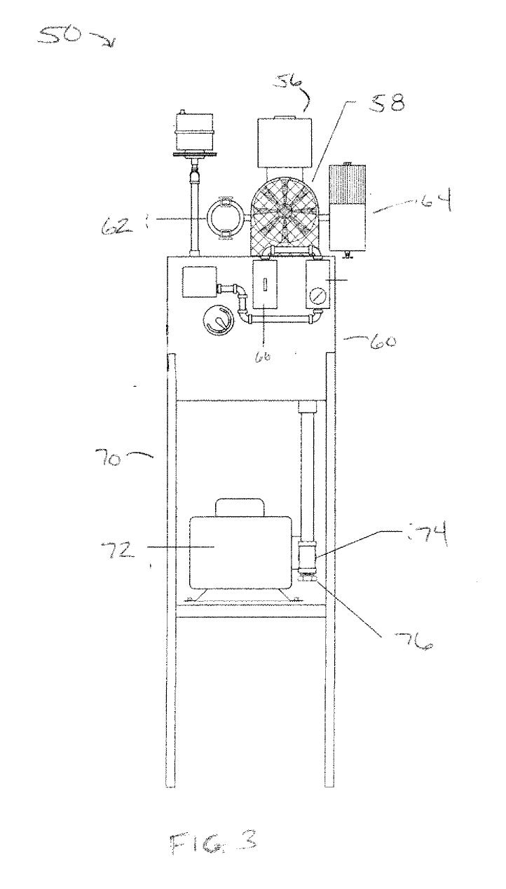

In some embodiments, the vacuum apparatus 50 includes a vacuum tank (see FIG. 3 below), and negative pressure in the sprinkler piping 20 is maintained by monitoring pressure in the tank of the vacuum apparatus 20. In such an embodiment, a pressure regulator 42 may be provided to activate and deactivate the vacuum apparatus based on actual conditions in the tank. The regulator may require a higher (i.e., more negative) vacuum pressure in the tank than is desired on the system 20. For example, to maintain a vacuum of about −10 inches in the sprinkler system 20, the pressure regulator 42 may turn vacuum apparatus 50 on when pressure in the tank reaches −10 inches or a more positive number and it may turn vacuum apparatus 50 off when pressure in the tank reaches −15 inches or a more negative number. Other vacuum levels are possible without departing from the scope of the invention.

Source 24 may be the same source as the primary water source 16, or it may be a different source The pin 14 triggers the camber 15 and releases the seat 11 when water pressure from pipe 22 is relieved and diaphragm 43 moves outward. Water pressure may be relieved in pipe 22 in one or more ways.

In an embodiment, a first solenoid 28 may relieve the water pressure in pipe 22 by triggering a first valve 26 to open and allow water from source 24 to be directed to a drain 34. The first solenoid 28 may be activated by the detection of heat and/or smoke that would be indicative of a fire that requires activation of the sprinkler system 20. The first solenoid 28 may include heat and/or smoke detection capabilities, or it may be connected to a separate heat and/or smoke sensor (not shown).

In an embodiment, a vacuum loss detection mechanism 32 may relieve the water pressure in pipe 22 by triggering a second valve 30 to open and allow water from source 24 to be directed to the drain 34. The vacuum loss detection mechanism 32 may directly detect an undesired increase in pressure or accidental loss of vacuum in the piping system 20, or a vacuum sensor (not shown) located within the piping system 20 may trigger the vacuum loss detection mechanism 32.

In an embodiment, either the heat/smoke sensor or the vacuum loss detection mechanism 32 may direct water from source 24 away from the piping system 20 toward the drain 34. However, in an alternate embodiment, both the heat/smoke sensor and the vacuum loss detection mechanism 32 must be activated in order to direct water from source 24 away from the piping system 20 toward the drain 34 and open the seat 11 in valve 11. In an alternate embodiment, the vacuum loss detection mechanism 32, when activated, may signal the vacuum apparatus 50 to apply a vacuum to the piping system 20.

Applicants have discovered that if oxygen is substantially removed from the sprinkler network 20 and a vacuum—i.e., a negative pressure and evacuated condition is applied to the system and maintained, any bacteria that is present within the system will remain dormant and will not grow. The removal of the oxygen from the system under vacuum retards the growth of aerobic bacteria that may be present in the system. The vacuum condition will also substantially eliminate any residual water that might be present in the dry sprinkler system, and thereby remove the environment needed for both anaerobic and aerobic bacteria to grow. Accordingly, MIC can be inhibited by maintaining a vacuum in the system. As used herein the terms “evacuated condition” and “vacuum” do not necessarily require a perfect vacuum (i.e., a total absence of air). However, they do require that a sufficient amount of air be removed from the system so that the remaining oxygen, if any, is not present in an amount sufficient for mold to grow.

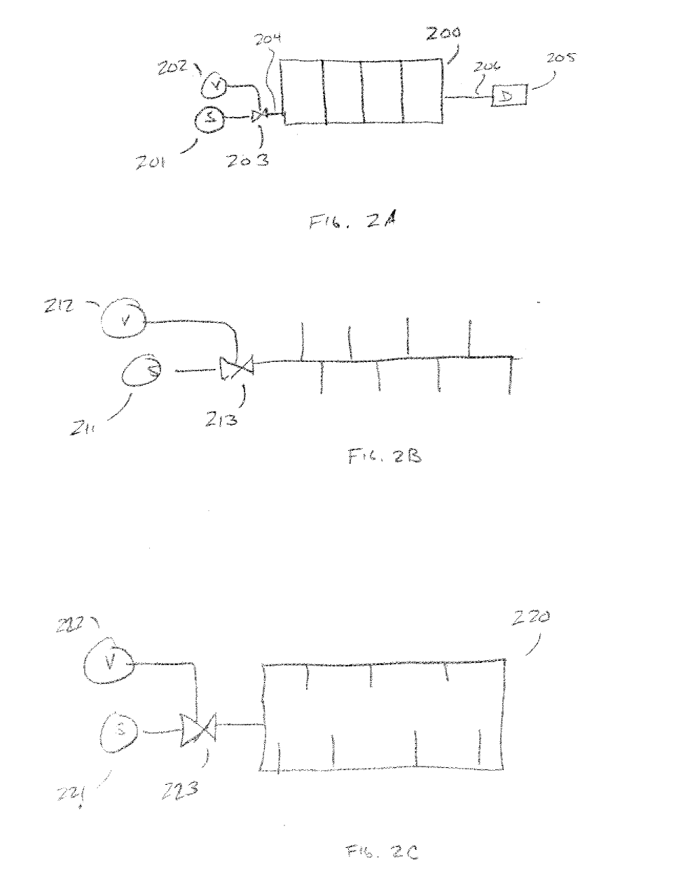

The methods and systems described herein may inhibit MIC growth and permit dry sprinkler systems to be used in many configurations. For example, referring to FIG. 2A sprinkler piping 200 may be configured in a grid configuration and receive water from a source 201 via valve 203. Vacuum apparatus 202 may remove oxygen from piping 200 and keep piping 200 in an evacuated condition in non-fire conditions.

Referring to FIG. 2B, sprinkler piping 210 may be configured in a grid configuration and receive water from a source 211 via valve 213. Vacuum apparatus 212 may remove oxygen from piping 210 and keep piping 210 in an evacuated condition in non-fire conditions.

Referring to FIG. 2C, sprinkler piping 220 may be configured in a loop configuration and receive water from a source 221 via valve 223. Vacuum apparatus 222 may remove oxygen from piping 220 and keep piping 220 in an evacuated condition in non-fire conditions.

In some embodiments, referring to FIG. 2A, to further assist or speed MIC control, a dryer 205 may be connected to the sprinkler network at a location that is distant from the vacuum apparatus 202. The dryer 205 may be any unit capable of removing humidity from air. To maintain negative pressure in the system, the dryer inlet 206 is much smaller than the outlet 204 channel from which air is removed from the sprinkler system. For example, dryer inlet 206 may be a conduit having an interior diameter that is five times smaller than that of outlet channel 204, ten times smaller than that of outlet channel 204 or another size that is smaller than the size of outlet channel 204. In this way, substantially all oxygen remains evacuated from the sprinkler network 200 because air may be withdrawn from channel 206 at a rate faster than air may enter through dryer conduit 206. This arrangement may be used with any sprinkler system configuration.

Referring now to FIG. 3, a block diagram of elements of a vacuum apparatus 50 is shown. The apparatus includes a tank or vessel 52, a power source 56 and a vacuum pump 58. The power source 56 may be, for example, a one horsepower electric motor. The power source 56 may be operably connected to and may supply power to the vacuum pump 58 so that pump 58 removes air from tank 58.

The vessel 52 is preferably an ASME compliant tank. While the vessel 52 may be any size, the vessel 52 preferably has a 10 to 50 gallon capacity, and most preferably is of a size that does not make the apparatus 50 difficult to move and/or transport. However vessels of other sizes, such as vessels having five-gallon capacities or larger capacities, are possible. The vessel 52 may be made of a material that is impervious to water, such as a metal. Although a tank is described herein as vessel 52, it is recognized that other containers may be contemplated within the scope of this invention.

Vacuum pumps 58 contemplated for use with the invention may include a piston, a fan and one or more screw type pumps (e.g., cylinder bounded devices for moving fluids such as air), In an embodiment, a piston type vacuum pump 58 operating at 1725 revolutions per minute and capable of suctioning air from the network and generating a reduced pressure/pressure differential of approximately 0 to approximately 30 inches of mercury may be used. In such an embodiment, the vacuum pump 58 may create a stable reduced pressure of about 10 inches of mercury. It is also recognized that any vacuum pump capable of generating a stable reduced pressure of about 10 inches of mercury may be used and still fall within the scope of the invention, as most current sprinkler systems use couplings that can withstand a pressure of up to 10 inches of mercury. However, systems may operate at higher or lower vacuum pressures and still fall within the scope of the invention.

The power source 56, illustrated in FIG. 3, may be, for example, an electric motor capable of generating about three horsepower. However, it is also recognized that any power source or engine capable of generating power sufficient to operate the vacuum pump 58 nay be used and still fall within the scope of the invention. For example, the stability of the reduced pressure may increase and an increased number of sprinkler heads may be removed at once by using a motor with increased maximum horsepower,

Optionally, the vacuum apparatus may include any or all of the following additional elements: an air filter 62 to clean the air that enters the vacuum pump; a muffler 64 or other noise dampening device, a manual on/off control 66 such as a switch. Optionally, the vacuum apparatus may be supported by a frame 70 that also supports a water pump 74 and piping 74 that may be used to draw water from the sprinkler network when the sprinkler network is wet. The piping 74 may include a drain closure 76 that is opened when the water pump is activated.

In an embodiment, an effective pressure in an evacuated system for inhibiting microbial growth and MIC is at least about −2 inches of mercury. Preferably, the evacuated condition in the sprinkler system is about −10 inches of mercury. Any pressure that is lower than atmospheric pressure and which is effective in inhibiting MIC from aerobic bacteria may be used. Generally the lower the pressure, the more oxygen has been removed, and thus the more effective is the inhibition of microbial growth. The pressure of the evacuated system in embodiments herein is only limited by the pressure limitations of the design of the sprinkler system.

In an embodiment, a vacuum apparatus for controlling bacteria growth in a dry sprinkler system includes a vacuum pump that is connectable to a dry sprinkler system, When the vacuum apparatus is activated, a regulated vacuum is maintained on the sprinkler system that is effective in removing residual water, lowering the partial pressure of oxygen in the system and inhibiting microbial growth. The apparatus also includes a pressure regulator. The pressure regulator is designed to automatically re-establish an effective vacuum for inhibiting microbial growth, by the vacuum apparatus, when the pressure regulator detects a pressure change in the sprinkler system. The vacuum apparatus may be activated when the pressure regulator detects a if pressure above a predetermined level, or deactivated when the pressure regulator detects a pressure below a predetermined level. An effective vacuum for inhibiting microbial growth may be a pressure between about −2 to about −10 inches of mercury.

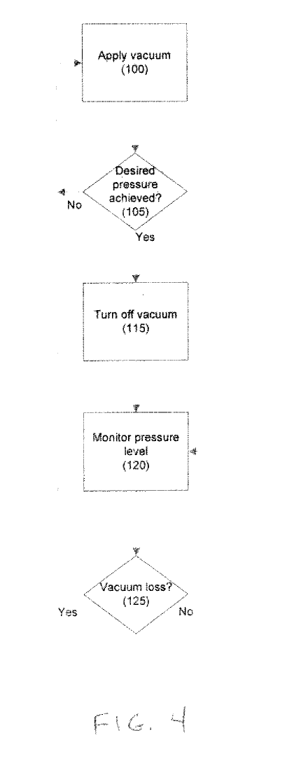

Referring to FIG. 4, in an embodiment, a method of controlling MIC in a sprinkler system includes providing an apparatus such as that discussed herein connecting the apparatus to a sprinkler system at alarm, and applying a reduced pressure within the system. The connection may occur at an alarm valve or another suitable location. Preferably the alarm valve may reside inside of the building which houses the sprinkler system. In this embodiment, the vacuum may be applied until a desired negative pressure level, such as −15 inches of mercury (105), is achieved in the vacuum tank. The vacuum apparatus may then be turned off (115). Then the system pressure within the vacuum tank may be monitored (120), and the vacuum apparatus may be restarted if a pressure increase occurs such that pressure within the tank is lost such as rising to a level that is less negative than −10 inches of mercury.

It is to be understood that the invention is not limited in its application to the details of construction and to the arrangements of the components set forth in this description or illustrated in the drawings. The invention is capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

What is claimed is:

1. A method of controlling bacteria growth in a sprinkler system, comprising:
operating a sprinkler network in a normally substantially dry condition;
applying a vacuum apparatus to evacuate air from the network and create a negative pressure within the network so that oxygen is removed and bacteria growth within the network is inhibited.

2. The method of claim 1, wherein the vacuum apparatus includes a tank, and the method further includes:
monitoring pressure within the tank;
deactivating the apparatus if pressure within the tank reaches a first predetermined level; and
restarting the apparatus if pressure within the tank reaches a second predetermined level.

3. The method of claim 2, wherein the pressure monitoring comprises using a pressure regulator.

4. The method of claim 2, wherein restarting comprises activating the vacuum apparatus when the pressure regulator detects a pressure that is not sufficient to control bacteria growth.

5. The method of claim 2, wherein the deactivating comprises comprising, deactivating the vacuum apparatus when the pressure regulator detects a pressure that is more negative than a predetermined level.

6. The method of claim 2, further comprising delivering air into the network through a dryer so that the delivered air is received into the network at a rate that is at least five times less than a rate that the evacuated air is removed from the network.

7. A method for controlling bacteria growth in a dry sprinkler system, comprising:
connecting a vacuum apparatus to a sprinkler system:
establishing, by the vacuum apparatus, an evacuated condition in the sprinkler system, wherein the evacuated condition comprises a negative pressure that is within a design pressure capability of the sprinkler system, wherein the evacuated condition inhibits bacteria growth in the sprinkler system;
monitoring, by a pressure regulator, pressure within a tank of the vacuum apparatus; and
automatically re-establishing, by the vacuum apparatus, the evacuated condition when the pressure regulator detects a predetermined pressure level within the tank.

8. The method of claim 7, wherein the predetermined pressure level comprises a negative pressure that is between about −2 inches and about −10 inches of mercury.

9. The method of claim 7, wherein the evacuated condition comprises removing at least 90% of oxygen from the system.

10. The method of claim 7, further comprising delivering air into the network through a dryer so that the delivered air is received into the network at a rate that is at least five times less than a rate that evacuated air is removed from the network.

11. A method of controlling bacteria growth in a sprinkler system, comprising:
operating a sprinkler network in a normally substantially dry condition,
applying a vacuum apparatus to evacuate air from the network and create a an evacuated condition within the network so that oxygen is removed and bacteria growth within the network is inhibited;
monitoring pressure within the vacuum apparatus;
deactivating the monitored pressure reaches a first level; and
restarting the apparatus if pressure within the tank reaches a second level.

12. The method of claim 11, wherein the pressure monitoring comprises using a pressure regulator.

13. The method of claim 11, wherein the second level a pressure that is not sufficient to control bacteria growth.

14. The method of claim 11, further comprising delivering air into the network through a dryer so that the delivered air is received into the network at a rate that is at least five times less than a rate that the evacuated air is removed from the network.

15. The method of claim 11, wherein the first level comprises a negative pressure that is between about −2 inches and about −10 inches of mercury.

16. The method of claim 11, wherein the evacuated condition comprises removing at least 90% of oxygen from the network.
